(19) United States
(12) Patent Application Publication
(10) Pub. No.: US 2026/0210559 A1
(43) Pub. Date: Jul. 23, 2026

(54) COOKING APPLIANCE AND METHOD FOR CLOSED-LOOP COOKING OPERATION

(71) Applicant: Haier US Appliance Solutions, Inc., Wilmington, DE (US)

(72) Inventor: Omar Santana, Louisville, KY (US)

(21) Appl. No.: 19/026,906

(22) Filed: Jan. 17, 2025

(51) Int. Cl. F24C 7/08; G05D 23/19; H05B 3/74

(52) U.S. Cl. CPC F24C 7/083; G05D 23/1902; H05B 3/748; H05B 2213/07

(57) ABSTRACT

A cooking appliance, controller and method for closed-loop cooking operation include acquiring a first command signal corresponding to initiating a closed-loop cooking operation. During the closed-loop cooking operation, a feedback parameter is acquired for controlling the heating operation of the heating element. A second command signal is acquired corresponding to terminating the closed-loop cooking operation. During a buffer period initiated from acquiring the second command signal, the feedback parameter is acquired for controlling the heating operation of the heating element. During the buffer period, a third command signal is acquired corresponding to initiating the closed-loop cooking operation. After acquiring the third command signal, the closed-loop cooking operation is restored based on the feedback parameter acquired during the buffer period. Acquisition of the feedback parameter is terminated after the buffer period elapses if the third command signal is not acquired during the buffer period.

### FIELD OF THE INVENTION

The present subject matter relates generally to cooking appliances, and more particularly to methods for operating cooking appliances.

### BACKGROUND OF THE INVENTION

Cooking appliances generally have one or more heating elements configured for heating a cookware item. The cookware item, e.g., a pot or a pan, may be positioned on or near the one or more heating elements and food products (including, e.g., food solids, liquid, or water) may be placed inside the cookware item for cooking. A controller may selectively energize the heating element(s) to provide thermal energy to the cookware item and the food products placed therein. Alternatively, certain cooking appliances, often referred to as induction cooktops, provide energy in the form of an alternating magnetic field which causes the cookware item to generate heat. In both types of appliances, a controller selectively energizes either the heating element(s) or a magnetic coil to heat the food products until they are properly cooked.

For cooking appliances that are capable of performing feedback controlled heating operations, one or more algorithms may be used to incorporate certain feedback information (e.g., temperature change, temperature rate of change, etc.) over a heating period to intelligently control a power level of the heating element(s). A set of controller gains (e.g., derivative, integral, etc.) may be utilized when the feedback controlled portion of the heating operation begins. When certain events happen, the controller output may be automatically adjusted based on the set of controller gains in use, such as to compensate for the sudden change in temperature.

When a user articulates various control interfaces (e.g., buttons, knobs), feedback controls may be disabled or altered, and automatic adjustments may be disabled or undesirably affected, which can cause lag and slowdowns for the feedback controlled system to reach a target temperature, or result in inaccurate temperature control. For instance, the user may rotate a control knob away from the feedback control position (e.g., “Precision Cooking”) to an open-loop position (e.g., Low to High) in an attempt to adjust the cooking temperature. However, the user may not realize that this operation would unintentionally terminate the feedback controlled operation.

Accordingly, a cooking appliance and method of operating a cooking appliance which obviates one or more of the above-mentioned drawbacks would be beneficial.

### BRIEF DESCRIPTION OF THE INVENTION

Aspects and advantages of the invention will be set forth in part in the following description, or may be obvious from the description, or may be learned through practice of the invention.

An aspect of the present disclosure is directed to a cooking appliance including a heating element configured to selectively supply heat to a cookware item; a temperature sensor configured to selectively monitor a temperature of the cookware item; and a controller operably connected with the heating element and the temperature sensor. The controller is configured to perform a heating operation. The heating operation includes acquiring, via articulation of a control interface, a first command signal corresponding to initiating a closed-loop cooking operation; acquiring, during the closed-loop cooking operation, a feedback parameter for controlling the heating operation of the heating element; acquiring, via articulation of the control interface, a second command signal corresponding to terminating the closed-loop cooking operation; acquiring, during a buffer period initiated from acquiring the second command signal, the feedback parameter for controlling the heating operation of the heating element; acquiring, during the buffer period, a third command signal corresponding to initiating the closed-loop cooking operation; restoring, after acquiring the third command signal, the closed-loop cooking operation based on the feedback parameter acquired during the buffer period; and terminating acquisition of the feedback parameter after the buffer period elapses if the third command signal is not acquired during the buffer period.

An aspect of the present disclosure is directed to a controller for a cooking appliance. The controller is configured to control a heating operation of the cooking appliance. The heating operation includes acquiring a first command signal corresponding to initiating a closed-loop cooking operation; acquiring, during the closed-loop cooking operation, a feedback parameter for controlling the heating operation; acquiring a second command signal corresponding to terminating the closed-loop cooking operation; acquiring, during a buffer period initiated from acquiring the second command signal, the feedback parameter for controlling heating operation; determining, after acquiring a third command signal during the buffer period, a control output for controlling the heating operation based on the feedback parameter acquired during the buffer period; and clearing memory associated with the feedback parameter acquired during the buffer period if the third command signal is not acquired during the buffer period.

An aspect of the present disclosure is directed to a method for controlling heating operation for a cooking appliance. The method includes acquiring a first command signal corresponding to initiating a closed-loop cooking operation; acquiring a feedback parameter for controlling the heating operation of the heating element; acquiring a second command signal corresponding to terminating the closed-loop cooking operation; acquiring, during a buffer period initiated from acquiring the second command signal, the feedback parameter for controlling the heating operation of the heating element; acquiring, during the buffer period, a third command signal corresponding to initiating the closed-loop cooking operation; restoring, after acquiring the third command signal, the closed-loop cooking operation based on the feedback parameter acquired during the buffer period; and terminating acquisition of the feedback parameter after the buffer period elapses if the third command signal is not acquired during the buffer period.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a side cut-away view of the exemplary cooking appliance of FIG. 1.

FIG. 3A provides a first view of an exemplary control for the cooking appliance of FIG. 1 according to an embodiment of the present disclosure.

FIG. 3B provides a second view of an exemplary control for the cooking appliance of FIG. 1 according to an embodiment of the present disclosure.

FIG. 4 provides an exemplary display for the cooking appliance of FIG. 1 according to an embodiment of the present disclosure.

FIG. 5 provides a graph illustrating a cookware setpoint and temperature and controller integral term over time according to exemplary embodiments of the present disclosure.

FIG. 6 provides an exemplary display for the cooking appliance of FIG. 1 according to an embodiment of the present disclosure.

FIG. 7 provides a flow chart illustrating a method of operating a cooking appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of a cooking appliance and method for closed-loop operation are provided. Embodiments provided herein may overcome feedback control issues associated with articulating between closed-loop and open-loop cooking operation. For instance, a user may articulate a control interface to command a closed-loop cooking operation. Subsequent articulation of the control interface may unintentionally or undesirably command termination of the closed-loop cooking operation. Embodiments of the cooking appliance and method provided herein may avoid time losses, temperature inaccuracies, or energy inefficiencies associated with restarting the closed-loop cooking operation. Additionally, embodiments provided herein may accommodate for intentional and unintentional termination of the closed-loop cooking operation.

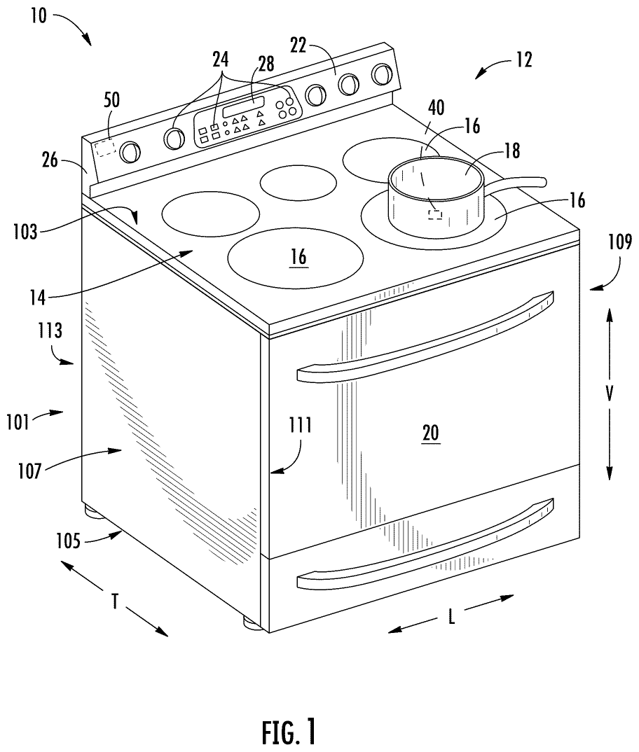

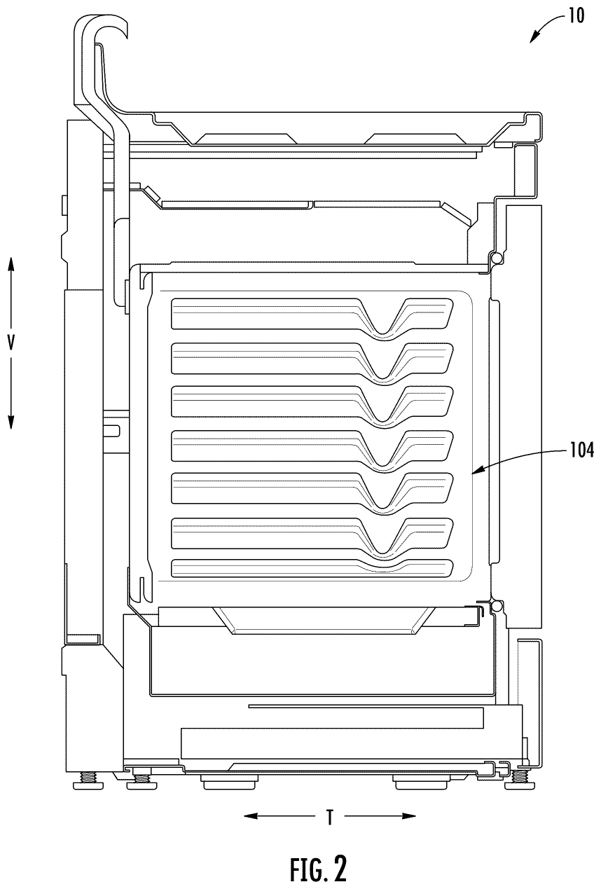

Referring now to the drawings, FIG. 1 provides a perspective view of a cooking appliance, or oven range 10, including a cooktop 12, and FIG. 2 provides a side cut-away view of the cooking appliance 10. Cooking appliance 10 is provided by way of example only and is not intended to limit the present subject matter to the arrangement shown in FIGS. 1 and 2. Thus, the present subject matter may be used with other range 10 and/or cooktop 12 configurations, e.g., double oven range appliances. As illustrated, cooking appliance 10 generally defines a vertical direction V, a lateral direction L, and a transverse direction T, each of which is mutually perpendicular, such that an orthogonal coordinate system is generally defined. Cooking appliance 10 may include a cabinet 101 that extends between a top 103 and a bottom 105 along the vertical direction V, between a left side 107 and a right side 109 along the lateral direction, and between a front 111 and a rear 113 along the transverse direction T.

A cooking surface 14 of cooktop 12 may include a plurality of heating elements 16. For the embodiment depicted, cooktop 12 includes five heating elements 16 spaced along cooking surface 14. Heating elements 16 may be electric heating elements and are positioned at, e.g., on or proximate to, the cooking surface 14. In certain exemplary embodiments, cooktop 12 is a radiant cooktop with resistive heating elements or coils mounted below cooking surface 14. However, in other embodiments, the cooktop appliance 12 includes other suitable shape, configuration, and/or number of heating elements 16, for example, cooktop 12 may be an open coil cooktop with heating elements 16 positioned on or above surface 14. Additionally or alternatively, in other embodiments, cooktop 12 may include any other suitable type of heating element 16, such as an induction heating element. Each of the heating elements 16 may be the same type of heating element 16, or cooktop 12 may include a combination of different types of heating elements 16.

As mentioned, heating element 16 may be an induction style heating element. Thus, as would be understood by those skilled in the art, appliance 10 may supply a current to heating element 16 (e.g., such as a Lenz coil). As such, current may pass through heating element 16 to generate a magnetic field. The magnetic field may be a high frequency circulating magnetic field. The magnetic field may be directed towards and through cooktop appliance 12 to a cookware item (e.g., cookware item 18, described below). In particular, when the magnetic field penetrates cookware item 18, the magnetic field induces a circulating electrical current within cookware item 18. The material properties of cookware item 18 may restrict a flow of the induced electrical current and convert the induced electrical current into heat within cookware item 18. As cookware item 18 heats up, contents of cookware item 18 contained therein heat up as well. In such a manner, the induction heating element can cook the contents of cookware item 18.

As shown in FIG. 1, a cooking utensil (or cookware item) 18, such as a pot, pan, or the like, may be placed on a heating element 16 to heat cookware item 18 and cook or heat food items placed within cookware item 18. Cooking appliance 10 may also include a door 20 that permits access to a cooking chamber 104 of oven range 10, e.g., for cooking or baking of food items therein. A control panel 22 having controls 24 may permit a user to make selections for cooking of food items. Although shown on a backsplash or back panel 26 of oven range 10, control panel 22 may be positioned in any suitable location.

Controls 24 may include buttons, knobs, and the like, as well as combinations thereof, and/or controls 24 may be implemented on a remote user interface device such as a smartphone. As an example, a user may manipulate one or more controls 24 to select a temperature and/or a heat or power output for each heating element 16 and the cooking chamber 104. The selected temperature or heat output of heating element 16 affects the heat transferred to cookware item 18 placed on heating element 16. A display 28 may be provided (e.g., on or in control panel 22). Display 28 may display information regarding cooking operations or inputs from a user regarding the cooking operation. Display 28 may be any suitable display capable of providing visual feedback, such as a liquid crystal display (LCD), a light emitting diode (LED) display, a segmented display, or the like. Additionally or alternatively, display 28 may be a touch display capable of receiving touch inputs from a user.

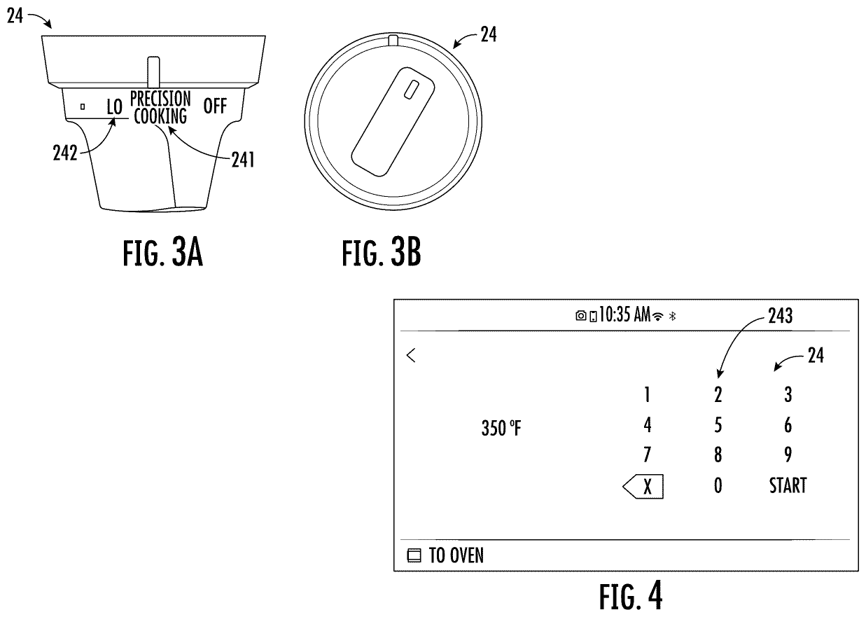

For instance, referring to FIGS. 3A-3B, an exemplary control 24 configured as a knob is provided. The control 24 may be articulated (e.g., rotated) by the user to select a heat or power output. Additionally, the control 24 may be utilized to select (or un-select) a closed-loop cooking operation (e.g., “Precision Cooking”, such as depicted in FIG. 3A). For instance, referring to FIGS. 3A-3B, the user may articulate the control 24 to command initiation of a closed-loop cooking operation (e.g., “Precision Cooking”).

Referring to FIG. 4, an exemplary display 28 is provided. The display 28 may include controls (e.g., buttons) configured to receive a user command corresponding to a desired temperature, heat, or power output. A target setpoint (e.g., temperature setpoint) is generated from the user command. In some embodiments, articulating the control 24 (e.g., depicted at FIGS. 3A-3B) to the closed-loop cooking operation (e.g., “Precision Cooking”) initiates a command or request for a target temperature setpoint (e.g., at display 28 depicted at FIG. 4). A target temperature setpoint is obtained and utilized by a controller for initiating and operating the cooking appliance as a feedback controlled heating operation.

Cooktop appliance 12 may further include or be in operative communication with a processing device or a controller 50 that may be generally configured to facilitate appliance operation. In this regard, control panel 22, controls 24, and display 28 may be in communication with controller 50 such that controller 50 may receive control inputs from controls 24, may display information using display 28, and may otherwise regulate operation of cooking appliance 10. For example, signals generated by controller 50 may operate cooking appliance 10, including any or all system components, subsystems, or interconnected devices, in response to the position of controls 24 and other control commands. Control panel 22 and other components of appliance 10 may be in communication with controller 50 via, for example, one or more signal lines or shared communication busses. In this manner, Input/Output (“I/O”) signals may be routed between controller 50 and various operational components of appliance 10.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 50 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 50 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 50 may be operable to execute programming instructions or micro-control code associated with an operating cycle of cooking appliance 10. In this regard, the instructions may be software or any set of instructions that when executed by the processing device, cause the processing device to perform operations, such as running one or more software applications, displaying a user interface, receiving user input, processing user input, etc. Moreover, it should be noted that controller 50 as disclosed herein is capable of and may be operable to perform any methods, method steps, or portions of methods as disclosed herein. For example, in some embodiments, methods disclosed herein may be embodied in programming instructions stored in the memory and executed by controller 50.

The memory devices may also store data that can be retrieved, manipulated, created, or stored by the one or more processors or portions of controller 50. The data can include, for instance, data to facilitate performance of methods described herein. The data can be stored locally (e.g., on controller 50) in one or more databases and/or may be split up so that the data is stored in multiple locations. In addition, or alternatively, the one or more database(s) can be connected to controller 50 through any suitable network(s), such as through a high bandwidth local area network (LAN) or wide area network (WAN). In this regard, for example, controller 50 may further include a communication module or interface that may be used to communicate with one or more other component(s) of appliance 10, controller 50, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Cooking appliance 10 may include a temperature sensor 40. Temperature sensor 40 may be configured to selectively sense a temperature of a cookware item (e.g., cookware item 18) as it is heated. For instance, temperature sensor 40 may be integrally formed with cooking appliance 10 (e.g., within cooktop 12, within cooking chamber 104, etc.). In some embodiments, temperature sensor 40 is operably connected to cooking appliance 10 (e.g., via a port or socket, via a remote connection, etc.). For one example, temperature sensor 40 is provided within cookware item 18 and operably connected to controller 50 during a cooking operation. Temperature sensor 40 may monitor a temperature of cookware item 18 or a food item provided within cookware item 18. Accordingly, temperature sensor 40 may deliver signals (e.g., voltage signals) representing the temperature of cookware item 18 to controller 50. The signals may be sent according to a predetermined frequency (e.g., at predetermined time intervals). Thus, controller 50 may analyze a temperature or temperature change of cookware item 18.

As used herein, “temperature sensor” or the equivalent is intended to refer to any suitable type of temperature measuring system or device positioned at any suitable location for measuring the desired temperature. Thus, for example, temperature sensor 40 may be any suitable type of temperature sensor, such as a thermistor, a thermocouple, a resistance temperature detector, a semiconductor-based integrated circuit temperature sensor, etc. In addition, temperature sensor 40 may be positioned at any suitable location and may output a signal, such as a voltage, to a controller that is proportional to or indicative of the temperature being measured. Although exemplary positioning of temperature sensors is described herein, it should be appreciated that appliance 10 may include any other suitable number, type, and position of temperature or other sensors according to alternative embodiments.

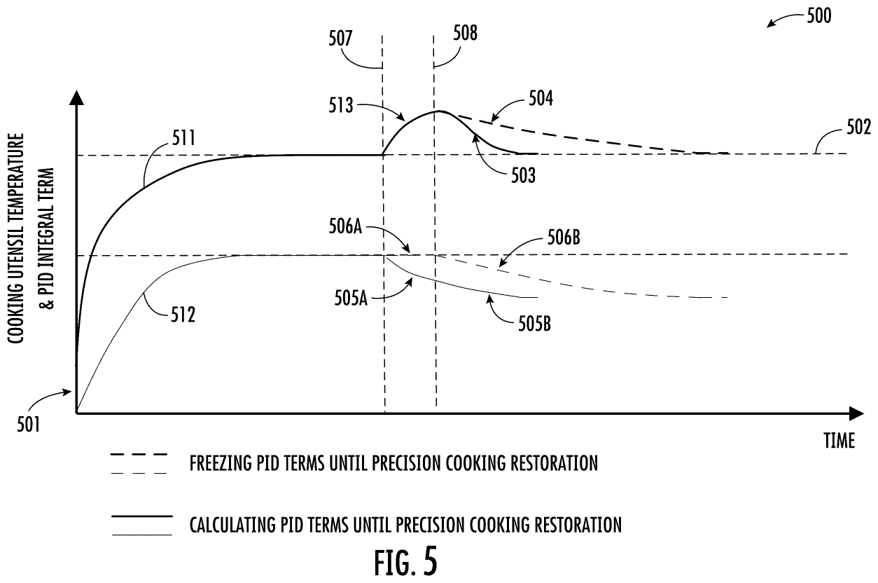

FIG. 5 provides a graph 500 illustrating an exemplary, non-limiting, cookware item setpoint (e.g., such as a temperature setpoint, line 502), a commanded termination time of closed-loop operation, such as articulating the control 24 away from the “Precision Cooking” position (line 507), a commanded re-initiation time of closed-loop operation, such as articulating the control 24 back to the “Precision Cooking” position (line 508), a cookware item temperature with PID terms calculation until “Precision Cooking” restoration (line 503), a cookware item temperature without PID terms calculation (e.g., PID terms are frozen or maintained constant) until “Precision Cooking” restoration (line 504), a controller integral term with PID terms calculation until “Precision Cooking” restoration (line 505), and a controller integral term without PID terms calculation (e.g., PID terms are frozen or maintained constant) until “Precision Cooking” restoration (line 506).

The heating operation may include a preheating phase, a cooking phase, or both, configured as one or more feedback controlled heating phases. The heating operation may intelligently adjust one or more parameters according to feedback with respect to cookware item 18, a food being cooked, cooking appliance 10, or the like (e.g., “feedback parameter(s)”). The feedback controlled heating operation (e.g., closed-loop controlled heating operation) may initiate with user articulation of the control 24 to a “Precision Cooking” operation. Temperature sensor 40 may continually send temperature signals to controller 50 which may then determine, for instance, an error value associated with the feedback controlled heating operation. The error value may be a difference between a temperature setpoint (e.g., sensor temperature setpoint) and an actual observed temperature (e.g., via temperature sensor 40). The error value may be substituted into a feedback equation to determine an adjustment to be made to a control variable. For instance, the control variable may be a power level of heating element 16.

According to at least some embodiments, controller 50 includes a closed-loop feedback control algorithm. The closed-loop feedback control algorithm may be a proportional-integral-derivative (PID) algorithm or equation (e.g., equation or set of equations). In some embodiments, the algorithm may include a proportional algorithm, a proportional-integral algorithm, a proportional-derivative algorithm, or any suitable combination of terms. The PID controller may determine a proportional term (P), an integral term (I), and a derivative term (D). The PID algorithm may be:

$$C V = P + I + D$$

where CV is a controlled variable (e.g., power input to heating element 16), P is the proportional term, I is the integral term, and D is the derivative term. As can be seen, adding each of the P, I, and D terms generates a value for the power level of heating element 16. Each of the P, I, and D terms may be found as follows:

$$P = {K}_{p} * e$$

$$I = {I}_{p r e v} + {K}_{i} * e * {T}_{s}$$

$$D = {K}_{d} * ( e - {e}_{p r e v} ) / {T}_{s}$$

where Kₚ is a proportional gain value, Kᵢ is an integral gain value, K_{d} is a derivative gain value, e is an error value (e.g., a difference between a temperature setpoint and an observed temperature), Tₛ is a sampling time or sampling time rate (e.g., a rate at which a discrete system samples inputs), Iₚᵣₑᵥ is a previous integral term (e.g., at the previous sampling event), and eₚᵣₑᵥ is a previous error value (e.g., at the previous sampling event). As noted above, however, in some instances any suitable combination of P, I, and D terms may be incorporated into the algorithm.

In some instances, the derivative (D) term may be susceptible to high levels of noise. Thus, large oscillations of the D term may be observed throughout the feedback controlled heating operation. Accordingly, the D term may be subjected to a filtering technique to reduce the noise and obtain a more steady, predictable term over the heating operation. For one example:

$${D}_{filtered} = α * D + ( 1 - α ) * {D}_{{filtered}_{p r e v}}$$

where D_{filtered} is the filtered D term, D_{filteredprev} is the previous filtered D term (e.g., from a measuring point immediately preceding the current measuring point [previous sampling event]), and a is a filter smoothing factor, such that 0≤α≤1. As would be understood, a smaller value of a (e.g., closer to 0) would result in greater smoothing of the D term. Additionally or alternatively, the filtered D term incorporates previous D terms to provide smoother adjustments to the D term of the PID controller algorithm. With a smoother D term, fluctuations of the PID controller outputs may be reduced. Thus, the PID algorithm may be adjusted to:

$$C V = P + I + {D}_{filtered}$$

In various embodiments, the feedback controlled heating operation (e.g., the PID closed-loop controlled heating operation) initiates with user articulation of the control (e.g., control 24) to a closed-loop heating operation (e.g., “Precision Cooking”), or additionally, with setpoint inputs or cycle selections (e.g., food types, doneness, heating modes, etc.). At the initiation of the feedback controlled heating operation (e.g., line 501 in FIG. 5), the I term and/or the filtered D term may be initialized to zero or non-zero values. For instance, the initial I term incorporated at the beginning of the feedback controlled heating operation may be a positive, non-zero value. However, in various instances, the initial value of the I term, the filtered D term, or both, may be zero.

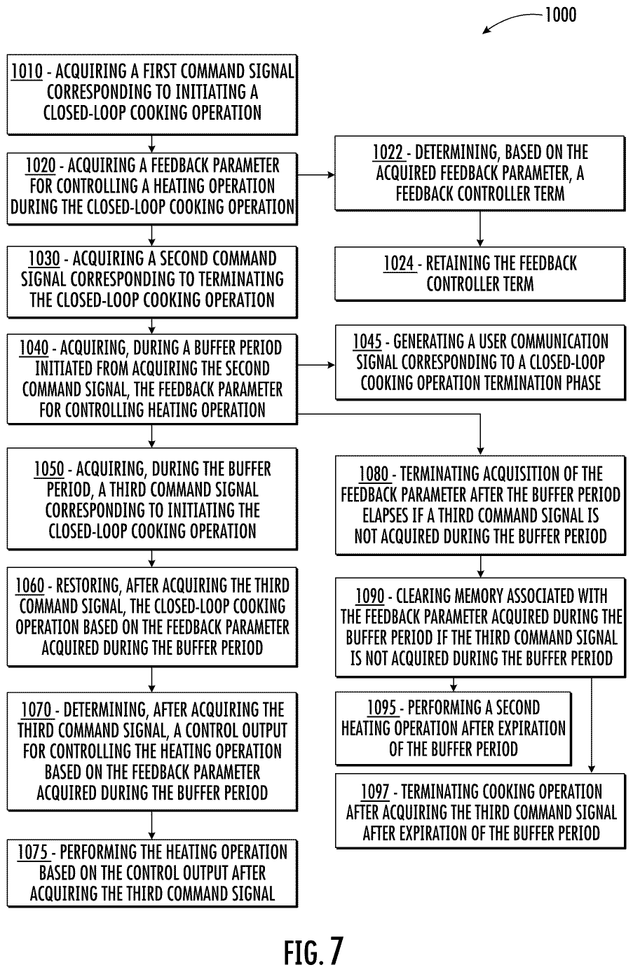

Now that the construction of cooking appliance 10 and a configuration of controller 50 according to exemplary embodiments have been presented, FIG. 7 provides a flowchart outlining steps of exemplary method 1000 of operating a cooking appliance. Although the discussion below refers to the exemplary method 1000 of operating cooking appliance 10, one skilled in the art will appreciate that the exemplary method 1000 is applicable to the operation of a variety of other cooking appliances. In exemplary embodiments, the various method steps as disclosed herein may be performed by controller 50 or a separate, dedicated controller. Additionally or alternatively, the various method steps may be performed in a different order, including additional steps or omitting certain steps according to specific embodiments.

Method 1000 includes at 1010 acquiring a first command signal corresponding to initiating a closed-loop cooking operation. As described herein, the closed-loop cooking operation may correspond to a “Precision Cooking” mode. The first command signal may be transmitted via articulation of a control interface (e.g., control 24, such as depicted at FIGS. 3A-3B and FIG. 4). For instance, the first command signal may include “Precision Cooking” mode selection and a temperature setpoint, cooking mode, or food item entry.

Method 1000 includes at 1020 acquiring a feedback parameter for controlling a heating operation of the heating element during the closed-loop cooking operation. The feedback parameter may include a sensed or measured cookware temperature or sensor temperature (e.g., via temperature sensor 40), or other appropriate measurement, signal, or feedback parameter for closed-loop control. In various embodiments, method 1000 may include at 1022 determining, based on the acquired feedback parameter, a feedback controller term. The feedback controller term may include an integral term (I), a filtered derivative term (filtered D), or both. For instance, in various embodiments, controller 50 is configured as a proportional (P), proportional-integral (PI), or proportional-integral-derivative (PID) controller. Method 1000 may include at 1024 storing, saving, or otherwise retaining (e.g., in memory at controller 50) the feedback controller term.

Method 1000 includes at 1030 acquiring a second command signal corresponding to terminating the closed-loop cooking operation. The second command signal may correspond to a termination of the first command signal. For instance, the second command signal may be transmitted via articulation of the control interface (e.g., control 24) from a closed-loop cooking mode (e.g., “Precision Cooking” mode, such as position 241 in FIG. 3A) to an open-loop cooking operation (e.g., a discrete power setting, such as position 242 in FIG. 3A). As such, the second command signal may include a termination of the first command signal corresponding to closed-loop cooking operation, and a command for initiating or performing an open-loop cooking operation.

Method 1000 includes at 1040 acquiring, during a period of time (buffer period) initiated from acquiring the second command signal, the feedback parameter for controlling the heating operation. The period of time may form a buffer period between obtaining or acquiring the second command signal and terminating acquisition of feedback parameters associated with closed-loop cooking operation. For instance, the buffer period may be approximately twenty (20) seconds, or approximately twenty-five (25) seconds, or approximately thirty (30) seconds, etc., or other duration from obtaining the second command signal. In various embodiments, method 1000 at 1040 may include determining, based on the acquired feedback parameter, the feedback controller term during the buffer period. In still various embodiments, method 1000 at 1040 may include storing, saving, or otherwise retaining in memory the feedback controller terms determined during the buffer period.

For instance, method 1000 at 1040 may include continuing determination, sensing, measurement, acquisition, and retention of feedback parameters and feedback controller terms corresponding to the closed-loop cooking operation (e.g., step 1020, 1022, 1024) after acquiring a signal to terminate the closed-loop cooking operation (e.g., step 1030).

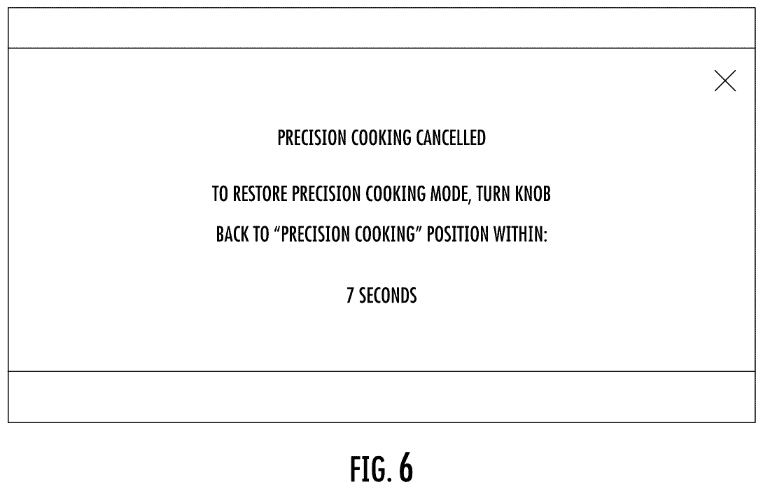

In some embodiments, method 1000 includes at 1045 generating a user communication signal corresponding to a closed-loop cooking operation termination phase corresponding with the buffer period. The user communication signal may include an audio signal, a visual signal, or combinations thereof. For instance, FIG. 6 depicts an exemplary user communication signal at display 28 including a message and countdown. The countdown corresponds to the buffer period in which the user may re-initiate or restore the closed-loop cooking operation based on the previous closed-loop cooking operation that was in place before the second command signal was acquired. However, it should be appreciated that embodiments of the controller 50, cooking appliance 10, and method 1000 may include or allow for manual termination of the buffer period, such as may cause initiation of a separate closed-loop cooking operation without waiting for expiration of the buffer period.

In some embodiments, the visual signal may include a light effect (e.g., colored lighting, strobes, changes in frequency and/or color, etc.) corresponding to initiation, countdown, or expiration of the buffer period. In still some embodiments, the audio signal may include an audible message indicative of initiation, countdown, or expiration of the buffer period.

Method 1000 includes at 1050 acquiring, during the buffer period, a third command signal corresponding to initiating the closed-loop cooking operation. The third command signal may be transmitted via articulation of the control interface, such as described in regard to the first command signal. For instance, acquiring the third command signal during the buffer period may correspond to commanding re-initiation or restoration of closed-loop cooking operation after obtaining a second command signal to terminate closed-loop cooking operation.

Method 1000 includes at 1060 re-initiating or restoring, after acquiring the third command signal, the closed-loop cooking operation based on the feedback parameter acquired during the buffer period. For instance, restoring the closed-loop cooking operation may occur upon acquiring the third command signal. The buffer period may be terminated upon or after acquiring the third command signal.

Method 1000 includes at 1070 determining, after acquiring the third command signal, a control output for controlling the heating operation based on the feedback parameter acquired during the buffer period. In some embodiments, determining the control output includes determining or calculating the feedback controller terms. Method 1000 at 1070 may include storing, saving, or otherwise retaining in memory (e.g., at controller 50), after acquiring the third command signal, one or more of the calculated feedback controller terms.

Method 1000 may include at 1075 performing the heating operation based on the control output after acquiring the third command signal.

Method 1000 includes at 1080 terminating acquisition of the feedback parameter after the buffer period elapses (e.g., after expiration of the buffer period) if a third command signal corresponding to initiating the closed-loop cooking operation is not acquired during the buffer period. Terminating acquisition of the feedback parameter after the buffer period elapses may include resetting at least one cooking setting corresponding to the closed-loop cooking operation (e.g., selected temperature setpoint, cooking mode, or food item).

Method 1000 may include at 1090 deleting, purging, or clearing a cache or memory associated with acquiring the feedback parameter during the buffer period if the third command signal is not acquired during the buffer period. For instance, acquiring the third command signal after the buffer period elapses (e.g., completion or time-out of the buffer period) may correspond to commanding a second closed-loop cooking operation. The second closed-loop cooking operation may generally form a separate cooking operation, such as may include cooking settings, temperatures, cycles, power settings, etc., separate or different from the cooking operation associated with the first command signal. For instance, commanding the second closed-loop cooking operation may contrast to restoring the closed-loop cooking operation paused or terminated at step 1030. In some embodiments, the third command signal after expiration of the buffer period corresponds to a termination of cooking operations (e.g., OFF command).

In some embodiments, method 1000 may include at 1095 performing a second heating operation after expiration of the buffer period. In some embodiments, the second heating operation is based on the second closed-loop cooking operation commanded from acquiring the third command signal after expiration of the buffer period. In still some embodiments, the second heating operation is based on an open-loop cooking operation.

In still some embodiments, method 1000 may include at 1097 terminating cooking operation after acquiring the third command signal after expiration of the buffer period.

In an exemplary embodiment of operation of cooking appliance 10 using method 1000, a user articulates the control 24 to a closed-loop cooking operation, such as position 241 in FIG. 3A (e.g., “Precision Cooking”). A first command signal is generated, transmitted, and acquired (e.g., step 1010) at controller 50 to initiate the closed-loop cooking operation. As further described above, step 1010 may further include further articulation of controls 24, such as to enter a desired temperature, etc., such as depicted at controls 243 (FIG. 4). Method 1000 further initiates acquisition of a feedback parameter for controlling heating operation of the heating element 16 in closed-loop cooking operation (e.g., step 1020).

When the control 24 is articulated away from the closed-loop cooking operation (e.g., articulated from position 241 to position 242 in FIG. 3A), termination of closed-loop cooking operation is commanded (e.g., step 1030). For instance, as provided herein, the second command signal may include termination of the first command signal. Additionally, or alternatively, generating, transmitting, and acquiring the second command signal may correspond to commanding initiation of an open-loop cooking operation.

Commanding termination of the closed-loop cooking operation initiates a buffer period (e.g., the period of time) over which acquisition, calculation, or determination of feedback parameters continues (e.g., step 1040) based on the closed-loop cooking operation associated with the first command signal (e.g., step 1010, 1020). Cooking appliance 10 performing step 1040 may calculate P, PI, or PID terms during the buffer period. Feedback parameters, settings, operational state, etc. associated with the closed-loop cooking operation from the first command signal are saved, or additionally, obtained and calculated (e.g., step 1040), during the buffer period even after acquiring the second command signal to terminate closed-loop cooking operation (e.g., step 1030).

In an exemplary operation of the cooking appliance 10 and method 1000, when the user articulates the control 24 back to the closed-loop cooking operation during the buffer period (e.g., articulate from position 242 back to position 241 during the buffer period), the feedback parameters obtained, calculated, or otherwise determined during the buffer period (e.g., step 1040) are utilized to re-initiate or restore operation of the closed-loop cooking operation (e.g., step 1060). For instance, the third command signal acquired in association with step 1050 includes the first command signal (acquired with step 1010) and feedback parameters and controller terms acquired or determined with steps 1020, 1040.

In still an exemplary operation of the cooking appliance 10 and method 1000, after the buffer period has elapsed (e.g., after 20 seconds, etc.) without obtaining the third command signal (i.e., without obtaining a command signal to re-initiate closed-loop cooking based on the first command signal obtained from step 1010), method 1000 resets (e.g., parameters, settings, states, etc. are cleared, such as step 1090). For instance, method 1000 resets to step 1010 without feedback parameters retained from the previous closed-loop cooking operation. For instance, acquired feedback parameters may be cleared from memory after lapse of buffer period without acquiring the third command signal (e.g., step 1090).

Referring to FIG. 5, in an exemplary, non-limiting embodiment of operation of method 1000, a first command signal is initiated at 501. Line 511 depicts an exemplary sensed cooking utensil temperature rising to temperature setpoint 502. Line 512 depicts an exemplary feedback parameter (e.g., PID integral term) corresponding to the cooking utensil temperature at 511 and the temperature setpoint at 502.

For example, the behavior of line 511 may correspond to user-selected settings, such as a selected temperature setpoint (e.g., 250F, 300F, etc.), a cooking mode (e.g., melt, keep warm, simmer, boil, pan frying, sear, etc.), or food item (e.g., fried eggs, toast, hash brown, salmon, spinach), e.g., using control 24, such as depicted at FIGS. 3A-3B, FIG. 4. In various embodiments, controller 50 configured as a PID controller may further save current PID term values (e.g., current I term value, current filtered D term value).

At line 507, a second command signal is acquired corresponding to termination of the closed-loop cooking operation, or furthermore, corresponding to initiating open-loop cooking operation. A buffer period initiates from line 507 (e.g., 20 seconds, 25 seconds, etc.).

In the exemplary, non-limiting embodiment, the second command signal corresponds to an open-loop cooking operation (e.g., a discrete power setting), such as a HIGH power setting greater than the power setting needed to maintain the cooking utensil temperature at temperature setpoint 502, and portion 513 of the cooking utensil temperature depicts a corresponding increase in temperature after obtaining the second command signal.

In an exemplary embodiment, line 508 corresponds to a third command signal acquired during the buffer period and corresponding to re-initiating the closed-loop cooking operation (e.g., associated with the first command signal obtained at 501). Portion 505A of the exemplary feedback parameter 512 continues acquisition, calculation, and determination during the buffer period from line 507, such that when the third command signal is acquired at time within the buffer period associated with line 508, portion 505B depicts continued determination of control output based on acquiring the feedback parameter during the buffer period. The corresponding temperature, depicted at portion 503 after acquiring the third command signal at line 508, controls and adjusts more quickly and accurately (e.g., the cooking utensil temperature rapidly returns to the temperature setpoint 502).

For example, if the closed-loop cooking operation is restored (e.g., steps 1050, 1060) after it has been terminated (e.g., step 1030), method 1000 restores the initial user-selected settings (e.g., associated with step 1010), and continues the closed-loop cooking operation where left off after acquiring the feedback parameter and accumulating or calculating the feedback controller terms (e.g., PID terms) during the buffer period (e.g., from line 507 until acquiring the third command signal). The feedback controller terms are restored to the last saved calculated values before the third command signal is acquired.

In contrast, portion 506A depicts an example of operation of a cooking appliance in which acquisition of the feedback parameter and calculation of the feedback controller terms are paused during the buffer period, in which the temperature rise associated with portion 513 is uncaptured. Line 506B depicts the restarting of acquisition of the feedback parameter and calculation of the feedback controller terms (e.g., PID terms) after the command signal for closed-loop cooking (e.g., the third command signal) is acquired after acquiring the second command signal terminating closed-loop cooking. Line 506B depicts a delayed or slower feedback response from line 508 in contrast to line 505B. Furthermore, portion 504 depicts a delayed or slower return to temperature setpoint 502 from line 508 in contrast to portion 503.

Embodiments of cooking appliance 10 and method 1000 such as described herein may improve heating operation performance, efficiency, and improve user control and experience, such as by overcoming feedback control issues associated with articulating between closed-loop and open-loop cooking operation, avoiding time losses, temperature inaccuracies, or energy inefficiencies associated with restarting a closed-loop cooking operation, and accommodating for intentional and unintentional termination of a closed-loop cooking operation.

Still various embodiments of the method 1000 may improve computing operations, such as may avoid excessive accumulation of parameters, signals, data, etc. relating to closed-loop cooking operations. Additionally, embodiments of the method 1000 may facilitate performance of closed-loop cooking operations while avoiding issues relating to excessive accumulation of parameters, signals, data, etc. at a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a heating element configured to selectively supply heat to a cookware item;
a temperature sensor configured to selectively monitor a temperature of the cookware item; and
a controller operably connected with the heating element and the temperature sensor, the controller configured to perform a heating operation, the heating operation comprising:
acquiring, via articulation of a control interface, a first command signal corresponding to initiating a closed-loop cooking operation;
acquiring, during the closed-loop cooking operation, a feedback parameter for controlling the heating operation of the heating element;
acquiring, via articulation of the control interface, a second command signal corresponding to terminating the closed-loop cooking operation;
acquiring, during a buffer period initiated from acquiring the second command signal, the feedback parameter for controlling the heating operation of the heating element;
acquiring, during the buffer period, a third command signal corresponding to initiating the closed-loop cooking operation;
restoring, after acquiring the third command signal, the closed-loop cooking operation based on the feedback parameter acquired during the buffer period; and
terminating acquisition of the feedback parameter after the buffer period elapses if the third command signal is not acquired during the buffer period.

2. The cooking appliance of claim 1, the operations comprising:
determining, after acquiring the third command signal during the buffer period, a control output controlling the heating operation based on the feedback parameter acquired during the buffer period.

3. The cooking appliance of claim 1, wherein terminating acquisition of the feedback parameter after the buffer period elapses comprises resetting a cooking setting corresponding to the closed-loop cooking operation.

4. The cooking appliance of claim 3, wherein terminating acquisition of the feedback parameter comprises clearing memory associated with acquiring the feedback parameter during the buffer period.

5. The cooking appliance of claim 1, wherein the second command signal comprises an open-loop cooking operation.

6. The cooking appliance of claim 1, the operations comprising:
generating a user communication signal corresponding to a closed-loop cooking operation termination phase.

7. The cooking appliance of claim 6, wherein the user communication signal comprises an audio signal, a visual signal, or combinations thereof.

8. The cooking appliance of claim 1, the operations comprising:
determining, over the buffer period, one or more of an integral term, a filtered derivative term, or both.

9. The cooking appliance of claim 1, wherein the heating operation comprises a closed-loop proportional-integral-derivative (PID) algorithm.

10. A controller for a cooking appliance, the controller configured to control a heating operation of the cooking appliance, the heating operation comprising:
acquiring a first command signal corresponding to initiating a closed-loop cooking operation;
acquiring, during the closed-loop cooking operation, a feedback parameter for controlling the heating operation;
acquiring a second command signal corresponding to terminating the closed-loop cooking operation;
acquiring, during a buffer period initiated from acquiring the second command signal, the feedback parameter for controlling heating operation;
determining, after acquiring a third command signal during the buffer period, a control output for controlling the heating operation based on the feedback parameter acquired during the buffer period; and
clearing memory associated with the feedback parameter acquired during the buffer period if the third command signal is not acquired during the buffer period.

11. The controller of claim 10, the operations comprising:
terminating acquisition of the feedback parameter after the buffer period elapses if the third command signal is not acquired during the buffer period.

12. The controller of claim 10, the operations comprising:
restoring, after acquiring the third command signal during the buffer period, the closed-loop cooking operation based on the feedback parameter acquired during the buffer period.

13. The controller of claim 10, wherein the second command signal comprises an open-loop cooking operation.

14. The controller of claim 10, the operations comprising:
generating a user communication signal corresponding to a closed-loop cooking operation termination phase.

15. The controller of claim 14, wherein the user communication signal comprises an audio signal, a visual signal, or combinations thereof.

16. The controller of claim 10, the operations comprising:
determining, over the buffer period, one or more of an integral term, a filtered derivative term, or both.

17. The controller of claim 10, wherein the heating operation comprises a closed-loop proportional-integral-derivative (PID) algorithm.

18. A method for controlling heating operation for a cooking appliance, the method comprising:
acquiring a first command signal corresponding to initiating a closed-loop cooking operation;
acquiring a feedback parameter for controlling the heating operation of the heating element;
acquiring a second command signal corresponding to terminating the closed-loop cooking operation;
acquiring, during a buffer period initiated from acquiring the second command signal, the feedback parameter for controlling the heating operation of the heating element;
acquiring, during the buffer period, a third command signal corresponding to initiating the closed-loop cooking operation;
restoring, after acquiring the third command signal, the closed-loop cooking operation based on the feedback parameter acquired during the buffer period; and
terminating acquisition of the feedback parameter after the buffer period elapses if the third command signal is not acquired during the buffer period.

19. The method of claim 18, comprising:
clearing memory associated with the feedback parameter acquired during the buffer period if a third command signal is not acquired during the buffer period.

20. The method of claim 18, comprising:
restoring, after acquiring the third command signal during the buffer period, the closed-loop cooking operation based on the feedback parameter acquired during the buffer period.
